(19) United States
(12) Patent Application Publication
(10) Pub. No.: US 2012/0279627 A1
(43) Pub. Date: Nov. 8, 2012

(54) Tire Comprising at Least Two Dual Layers

(75) Inventors: Michael Cogne, Riom (FR); Murielle De-Tullio, Clermont-Ferrand (FR)

(73) Assignees: Michelin Recherche et Technique S.A., Granges-Paccot (CH); COMPAGNIE GENERALE DES ETABLISSMENTS MICHELIN, Clermont-Ferrand (FR)

(21) Appl. No.: 13/508,987

(22) PCT Filed: Nov. 8, 2010
(86) PCT No.: PCT/EP2010/066978

§ 371 Date: Jul. 20, 2012

(30) Foreign Application Priority Data
Nov. 9, 2009 (FR) 0957897

(51) Int. Cl. B60C 9/18

(52) U.S. Cl. 152/526

(57) ABSTRACT

A tire comprising a crown reinforcement formed from at least two bilayers of parallel reinforcing elements in a ply, which bilayers are distributed with a constant pitch and crossed from one ply to another, and which do not have a free end at the edges thereof. Within a radial plane, the surface density of reinforcing elements in a region bounded by the geometric centers of four pairwise adjacent reinforcing elements, belonging in pairs to a bilayer, and forming a quadrilateral, is greater at the center of the tire than at the ends of the bilayers.

The invention relates to a tire comprising a crown reinforcement formed from at least two bilayers of parallel reinforcing elements in a ply, which are crossed from one ply to another and which do not have a free end at the edges thereof.

Although not limited to such an application, the invention will be more particularly described with reference to an aircraft tire. Aircraft tires are distinguished in particular by the combination of an inflation pressure greater than 9 bar and a relative deflection greater than 28%.

The deflection of a tire is defined by the radial deformation of the tire, or the variation in radial height, when said tire goes from the unloaded state to a statically loaded state, under nominal loading and nominal pressure conditions.

The deflection is expressed in the form of a relative deflection, defined by the ratio of this variation in the radial height of the tire to half the difference between the outside diameter of the tire and the maximum diameter of the rim, measured on the gutter. The outside diameter of the tire is measured statically in the unloaded state at the nominal pressure.

The tire according to the invention comprises a crown reinforcement consisting of at least two bilayers, thus forming four working plies, which are superposed and formed from parallel reinforcing elements in each ply and crossed from one ply to the next, making an angle to the circumferential direction of the tire. The presence of bilayers according to the invention thus makes it possible to have working plies in which the reinforcing elements do not have free ends at the ply edges.

Such bilayers make it possible to obviate the usual consequences due to the shear stresses generated by the free ends between the crown plies, which stresses contribute to a not insignificant rise in the operating temperature at the ends of said plies and which consequently cause the appearance and propagation of cracks in the rubber compound at said ends.

Bilayers in aircraft tires are usually produced using techniques consisting in depositing reinforcing elements or strips consisting of several reinforcing elements going continuously from one edge to the other in order to form a period or a multiple of a period per wheel revolution. Using these techniques, it is thus possible to produce working plies formed from parallel reinforcing elements in each ply and crossed from one ply to the next and which do not have free ends at the edges of plies, and therefore result in improving the endurance of the tires.

These bilayers can also be formed by a circumferential winding of a complex strip formed from two plies consisting of continuous reinforcing elements passing from one ply to the next. The complex strip may be obtained beforehand using a process consisting in crushing a tube, which is itself formed by the winding with touching turns, at a given angle to the longitudinal direction of the tube, of a strip in which reinforcing elements are parallel to each other and to the longitudinal direction of said strip and are encapsulated in a polymer compound. The width of the strip is adjusted according to the angle at which the turns are wound, so as to make them touching turns. Upon crushing said tube, the turns being perfectly contiguous, the complex strip obtained consists of two plies of continuous reinforcing elements passing from one ply to the other, said reinforcing elements being parallel in one ply and crossed from one ply to the other at angles to the circumferential direction that are identical in absolute value. By producing a tube with touching turns it is possible to obtain linear reinforcing elements in each of the plies, except at the axial ends of each of the plies, at which the reinforcing elements form loops so as to ensure continuity from one ply to the next.

This second technique, consisting in a circumferential winding, has the advantage of being simple to implement and able to be carried out at high speed.

The first production technique does actually result in longer manufacturing times.

Cords are said to be inextensible when they have a relative elongation of at most equal to 0.2% under a tensile force equal to 10% of the breaking force.

Cords are said to be elastic when they have a relative elongation of at least equal to 4% under a tensile force equal to the load at break.

The circumferential direction of the tire, or longitudinal direction, is the direction corresponding to the periphery of the tire and defined by the running direction of the tire. Circumferential reinforcing elements are elements making angles to said direction that lie within the [+2.5° to −2.5° ] interval about 0°.

The transverse or axial direction of the tire is parallel to the rotation axis of the tire.

The radial direction is a direction cutting the rotation axis of the tire and perpendicular thereto. Substantially radial reinforcing elements are elements making angles to the meridional direction that lie within the [+5° to −5° ] interval about 0°.

The rotation axis of the tire is the axis about which it rotates in normal use.

A radial or meridional plane is a plane that contains the rotation axis of the tire.

The circumferential mid-plane, or equatorial plane, is the plane perpendicular to the rotation axis of the tire that divides the tire into two halves.

The resulting aircraft tires produced according to one or other of the techniques described above are limited in terms of endurance owing to the breakage of reinforcing elements of the bilayers in the shoulder regions of the tire. The time delays before these breaks appear, or else the conditions under which they appear, are completely acceptable from the industrial standpoint, including when retreading of the tire is envisaged.

The inventors however, tasked with the mission of providing tires of improved endurance performance compared with the usual tires in particular for combining significant improvements in the wear of the tires, and especially in which the appearance of breaks in the reinforcing elements of the bilayers of the crown reinforcement in the shoulder regions is further delayed or even almost non-existent.

This objective is achieved according to the invention by a tire comprising a crown reinforcement formed from at least two bilayers of parallel reinforcing elements in a ply, which bilayers are distributed with a constant pitch and crossed from one ply to another, and which do not have a free end at the edges thereof, in which tire, within a radial plane, the surface density of reinforcing elements in a region bounded by the geometric centers of four pairwise adjacent reinforcing elements, belonging in pairs to a bilayer, and forming a quadrilateral, is greater at the center of the tire than at the ends of the bilayers.

In the context of the invention, the pitch is equal to the distance between two reinforcing elements measured along the direction normal to the principal axis of the reinforcing elements.

In the context of the invention, the surface density is equal to the area occupied by the reinforcing elements divided by the area bounded by a parallelogram, the vertices of which are the geometric centers of four reinforcing elements that are pairwise adjacent and belong in pairs to two radially adjacent plies, each of the plies belonging to a different bilayer. It is expressed as a percentage of reinforcing elements.

According to the invention, since the surface density of reinforcing elements is greater at the center of the tire than at the ends of the bilayers, the amount of polymer compound present between the reinforcing elements is greater at the ends of the plies of reinforcing elements than at the center of the tire.

According to another embodiment of the invention, since the pitch is constant, the radial distance between two adjacent reinforcing elements each belonging to one ply of a bilayer, said plies being radially adjacent, is greater at the ends of the bilayers than at the center of the tire.

In the context of the invention, the radial distance between the respective reinforcing elements of each of the crown plies is measured radially between the respectively upper and lower generatrices of said reinforcing elements of the radially inner and radially upper crown plies.

The inventors have demonstrated that the tires thus produced can run, under particularly severe conditions, further than is usual without the appearance of any breakage of reinforcing elements at the ends of the plies or more precisely the bilayers of the crown reinforcement.

The inventors interpret this improvement in terms of endurance performance to the fact that there is a greatly reduced risk of reinforcing elements of two adjacent plies coming into contact with one another. This is because it is usual for the layers of polymer compound that surround the reinforcing elements, called calendering layers, to be relatively thin and in the case of tires for large aircraft, these calendering layers undergo relatively large deformations during the various manufacturing phases that involve deformation of the calendering polymer compounds, especially creep deformation. The reinforcing elements of two radially adjacent plies, each ply belonging to a bilayer, may thus risk coming into contact with one another, the rubbing actions during use of the tire possibly causing them to break. Since the deformations undergone by these calendering layers during manufacture of a tire are larger at the shoulders, because of the very shape of the tire, this interpretation explains the presence of breaks in the reinforcing elements at the ends of the bilayers. Furthermore, when the tire is rolling, it is also at the ends of the bilayers that the variations in tensile stress are at a maximum during a wheel revolution. This helps to initiate breaks of the elementary constitute threads of the reinforcing elements and then promotes rubbing between reinforcing elements.

According to a preferred embodiment of the invention, within a radial plane, at the ends of the bilayers, the surface density of reinforcing elements in a region bounded by the geometric centers of four pairwise adjacent reinforcing elements, belonging in pairs to a bilayer, and forming a quadrilateral, is less than 45%. Above such a surface density of reinforcing elements, the benefit in terms of grip performance is no longer as great, breaks in the reinforcing elements possibly appearing under particularly detrimental uses of the tires.

Also preferably, within a radial plane, at the center of the tire, the surface density of reinforcing elements in a region bounded by the geometric centers of four pairwise adjacent reinforcing elements, belonging in pairs to a bilayer, and forming a quadrilateral, is more than 55%. Since the reinforcing elements of the central part of the reinforcement are less stressed, firstly during manufacture and secondly during use of the tires, the lesser amount of polymer compound present is still sufficient.

The invention also proposes a tire comprising a crown reinforcement formed from at least two bilayers of parallel reinforcing elements in a ply, which bilayers are distributed with a constant pitch and crossed from one ply to another, and which do not have a free end at the edges thereof, in which tire, within a radial plane, at the end of the bilayers, the ratio of the radial distance between two reinforcing elements of two adjacent plies, each ply belonging to a bilayer, to the radial distance between two reinforcing elements of the two plies of a bilayer is greater than 1.5, and preferably greater than 2.

According to this embodiment of the invention, the tire has at the ends of the bilayers, a greater amount of polymer compound between the reinforcing elements of two adjacent plies, each of the plies belonging to a different bilayer, than between two reinforcing elements of the plies of any one bilayer. This same ratio at the center of the tire is close to one, which means that the amount of polymer compound between the reinforcing elements of two adjacent plies, each of the plies belonging to a different bilayer, is substantially identical to that present between two reinforcing elements of the plies of any one bilayer. Since each of the plies is formed from reinforcing elements between two polymer compound calendering layers each forming a thickness radially to the outside and radially to the inside of said reinforcing elements respectively, the radial distance between the respective reinforcing elements of each of the crown plies at the center of the tire is substantially equivalent to the sum of the thickness of polymer compound of the calendering layer radially to the outside of the reinforcing elements of the radially inner crown ply and of the thickness of polymer compound of the calendering layer radially to the inside of the reinforcing elements of the radially outer crown ply.

One advantageous embodiment of the invention provides for at least one layer of polymer compound to be placed radially between the ends of two bilayers. During manufacture of the tire, it is thus possible to interpose a layer of polymer compound between depositing two bilayers, so as to increase the amount of polymer compound, in this region of the tire, between the reinforcing elements of two adjacent plies, each of the plies belonging to a different bilayer. Depending on the desired thickness of polymer compound, it is possible to superpose several layers. The presence of several layers may furthermore enable property gradients to be created between these various layers. For example, it is thus possible to vary the elastic modulus along the radial direction from one ply to the next.

According to this embodiment of the invention, within a radial plane, the axially inner end of said at least one layer of polymer compound is preferably at an axial distance from the equatorial plane of less than ⅘ of the axial half-width of the widest bilayer to which it is adjacent. The polymer layer thus covers at least ⅕ of the half-width of the widest bilayer to which it is adjacent and provides a surface density of reinforcing elements below the value chosen in this region.

Also advantageously according to this embodiment, within a radial plane, the axially outer end of said at least one layer of polymer compound is axially to the outside of the axially outer end of the widest bilayer to which it is adjacent. The polymer layer thus advantageously covers the end of the widest bilayer to which it is adjacent and consequently the axially outer end of the other bilayer.

A preferred embodiment of the invention provides for the reinforcing elements of the crown reinforcement plies to be inclined at an angle of between −20° and +20°, preferably to between −10° and +10°, to the circumferential direction.

An advantageous embodiment of the invention provides for the reinforcing elements of the crown reinforcement plies to be made of textile materials, preferably aliphatic polyamide and/or aromatic polyamide textile materials. Advantageously, the reinforcing elements are composite cords, such as those described in the patent application WO 02/085646.

Also advantageously, when the crown reinforcement of said tire comprises at least one ply of circumferential reinforcing elements, the circumferential reinforcing elements are made of textile materials, preferably aliphatic polyamide and/or aromatic polyamide textile materials. The crown reinforcement of the aircraft tires advantageously comprises plies of circumferential reinforcing elements, especially ensuring hoop reinforcement at the centre of the crown of the tire, the angles made by the reinforcing elements to the circumferential direction being advantageously less than 5°.

According to a preferred embodiment of the invention, the carcass reinforcement of the tire consists of at least one ply of mutually parallel reinforcing elements oriented substantially radially, the reinforcing elements of said at least one carcass reinforcement ply being made of textile materials, preferably aliphatic polyamide and/or aromatic polyamide textile materials. Advantageously, the reinforcing elements are composite cords such as those described in the patent application WO 02/085646.

According to other embodiments of the invention, the crown reinforcement may also be supplemented radially to the outside by at least one additional ply, called a protective ply, of elastic reinforcing elements, oriented to the circumferential direction at an angle between 10° and 45° and in the same sense as the angle made by the elements of the complex strip which is radially adjacent thereto.

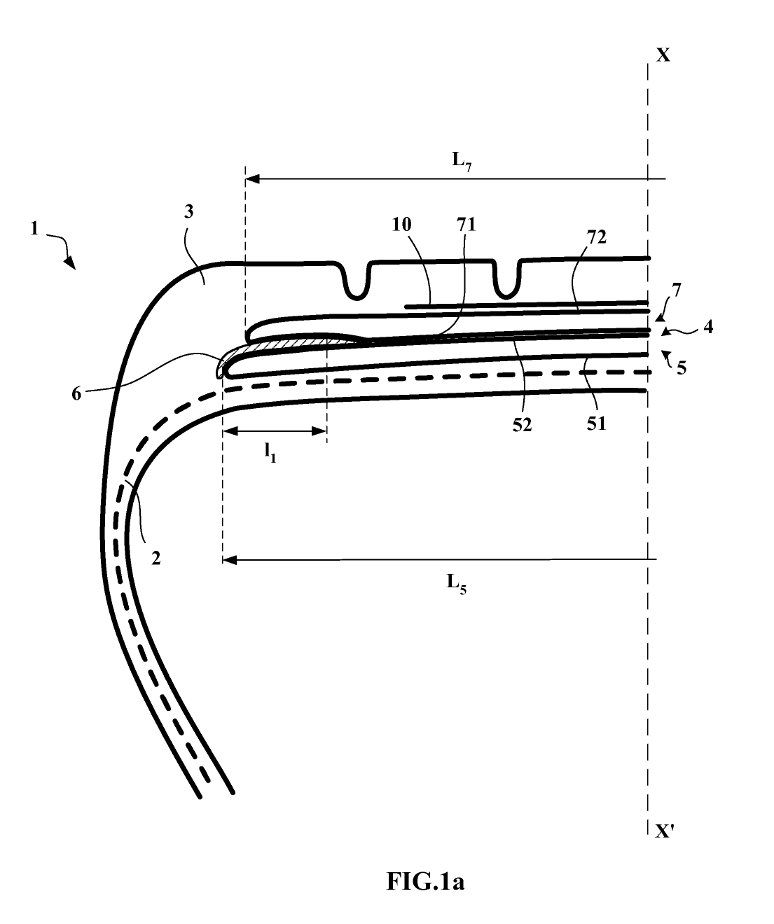

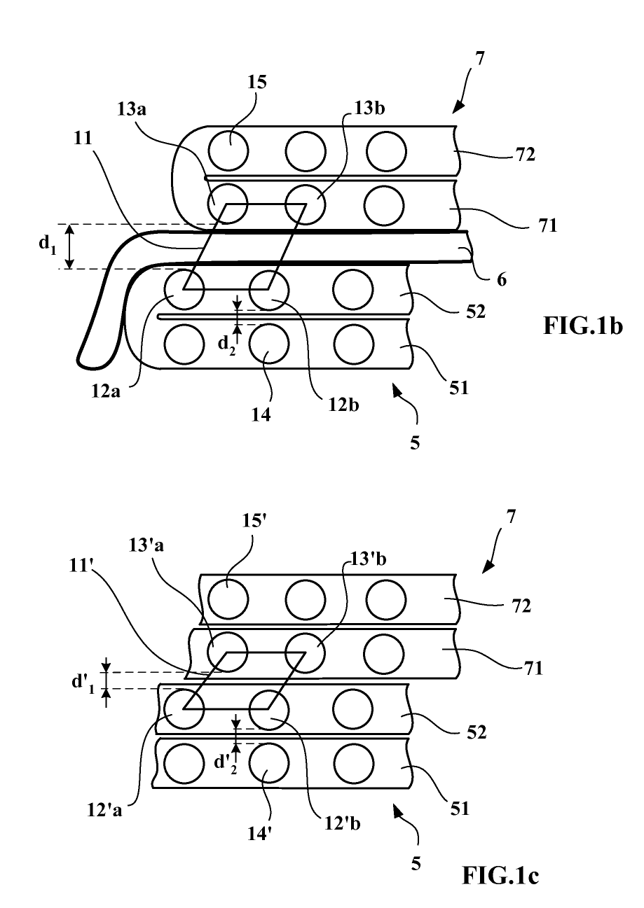

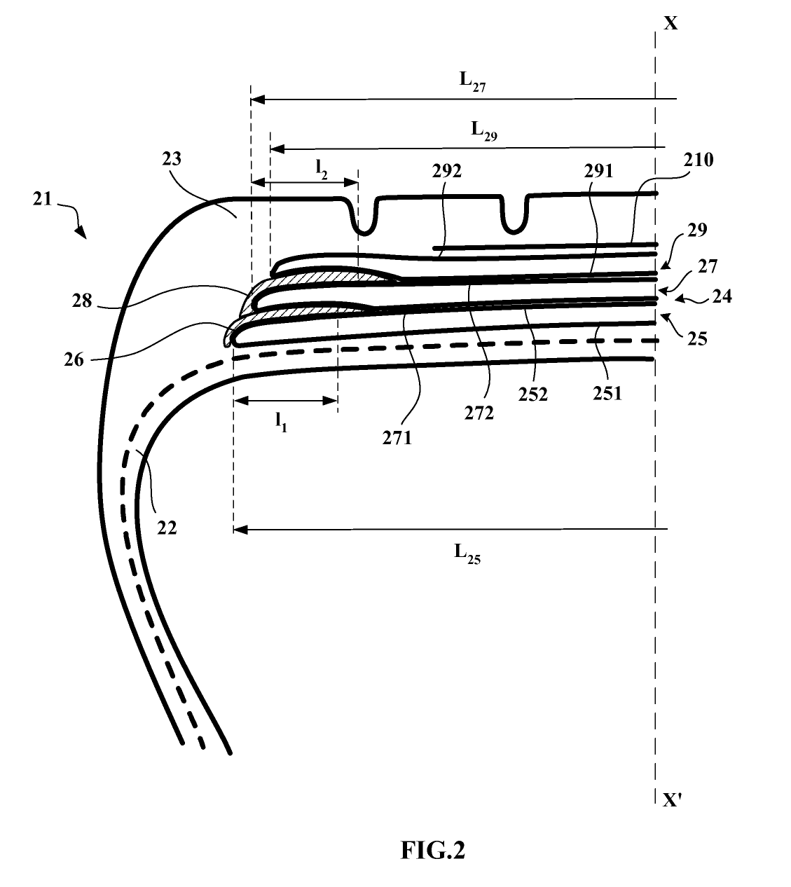

Other advantageous features and details of the invention will become apparent below from the description of various embodiments of the invention with reference to FIGS. 1 and 2 which show:

FIG. 1a, a meridional view of a diagram of a tire according to one embodiment of the invention;

FIG. 1b, an enlarged partial view of part of the diagram shown in FIG. 1a;

FIG. 1c, an enlarged partial view of another part of the diagram shown in FIG. 1a; and

FIG. 2, a meridional view of a diagram of a tire according to a second embodiment of the invention.

The figures have not been drawn to scale in order to make it simpler to understand them. FIGS. 1a and 2 show only a half-view of a tire, which extends symmetrically with respect to the axis XX′, which represents the circumferential mid-plane, or equatorial plane, of the tire.

FIG. 1a illustrates a tire 1 comprising a radial carcass reinforcement 2 anchored in two beads (not shown in FIG. 1) and surmounted by a tread 3. The carcass reinforcement 2 also has a crown reinforcement 4 as hoop reinforcement.

The crown reinforcement 4 is formed, radially from the inside towards the outside:
from a first bilayer 5 comprising two plies 51, 52 not having free ends on the edges of the bilayer 5. This bilayer 5 is for example obtained by traverse winding of a strip consisting of eight mutually parallel reinforcing elements. The traverse winding corresponds to laying down the strip from one edge to the other continuously, so as to form a period or a multiple of a period per wheel revolution. This technique of laying down the strip makes it possible to produce the plies 51, 52, the reinforcing elements being parallel in each ply and crossed from one ply to the next and not having free ends at the edge of a ply; then
from a layer of rubber 6 covering the end of the bilayer 5 and therefore the end of the ply 52; and
from a second bilayer 7 comprising two plies 71, 72, which is identical to the bilayer 5 and produced substantially in the same way, but with a smaller width.

The crown reinforcement 4 further includes a protective ply 10 consisting of metal reinforcing elements, said ply being the radially outermost ply of the crown reinforcement 4.

The reinforcing elements of the strip constituting the plies 51, 52, 71 and 72 are composite cords consisting of two aromatic polyamide spun yarns, each spun yarn having a linear density of 330 tex, individually overtwisted with a S-twist of 230 turns/meter and of an aliphatic polyamide spun yarn, the linear density of which is equal to 188 tex, said spun yarn being individually overtwisted with an S-twist of 230 turns/meter. The three spun yarns twisted beforehand on themselves are then twisted together with a Z-twist of 230 turns/meter to form the cord ready for use in the plies of the tire. The cord thus prepared has a diameter of 1.1 mm.

The strip is prepared from eight cords distributed with a laying pitch equal to 1.37 mm between two rubber calendering layers each having a thickness of 0.21 mm. The strip is deposited by traverse winding so that the reinforcing elements make an angle of between 6° and 10° to the circumferential direction.

The width L₅ of the bilayer 5 is 300 mm.

The width L₇ of the bilayer 7 is 280 mm.

The rubber layer 6 covers the end of the bilayer 5 over a width l₁ equal to 35 mm and therefore over a length slightly greater than 1/10 of the width of said bilayer 5. The layer 6 has a thickness of 0.6 mm over this width lᵢ, said layer extending slightly with a progressively decreasing thickness so as to form a transition zone.

FIG. 1b illustrates in greater detail the region of the ends of the two bilayers 5 and 7 between which a layer of polymer compounds 6 is deposed radially. This FIG. 1b shows a parallelogram 11, the vertices of which correspond to the centers of four mutually adjacent reinforcing elements 12a, 12b, 13a, 13b which belong in pairs to the plies 52 and 71. In this region of the tire, the reinforcing elements 12a, 12b of the ply 52 are radially separated from the elements 13a, 13b of the ply 71 by the rubber layer 6.

The radial distance d₁ between the elements 12 and 13 in this region of the bilayers is equal to 1 mm.

In the same region of the tire, the radial distance d₂ between two reinforcing elements 12 and 14 of the two plies 51, 15 of the bilayer 5 or between two reinforcing elements 13 and 15 of the two plies 71, 72 of the bilayer 7 is equal to 0.4 mm.

The ratio d₁/d₂ is equal to 2.5 and therefore greater than 2, in accordance with the invention.

The parallelogram 11 has an area equal to 2.22 mm². From this it may be deduced that the surface density of reinforcing elements is equal to 43% and therefore, in accordance with the invention, less than 45%.

FIG. 1c illustrates in greater detail the region of the center of the tire, in which the rubber layer 6 is absent. This FIG. 1c shows a parallelogram 11′, the vertices of which correspond to the centers of four mutually adjacent reinforcing elements 12′a, 12′b, 13′a, 13′b which belong in pairs to the plies 52 and 71.

The radial distance d′₁ between the elements 12′ and 13′ in this region of the bilayers is equal to 0.4 mm.

In the same region of the tire, the radial distance d′₂ between two reinforcing elements 12′ and 14′ of the two plies 51, 52 of the bilayer 5 or between two reinforcing elements 13′ and 15′ of the two plies 71, 72 of the bilayer 7 is equal to 0.4 mm.

The ratio d′₁/d′₂ is equal to 1, in accordance with the invention.

The parallelogram 11′ has an area of 1.53 mm². From this it may be deduced that the surface density of reinforcing elements is equal to 62% and therefore, in accordance with the invention, greater than 55%.

The surface density of reinforcing elements in a region bounded by the geometric centers of four pairwise adjacent reinforcing elements, belonging in pairs to a bilayer, and forming a quadrilateral, is therefore, in accordance with the invention, greater at the center of the tire than at the ends of the bilayers.

FIG. 2 illustrates a tire 21 comprising a radial carcass reinforcement 22 anchored in two beads (not shown in FIG. 2) and surmounted by a tread 23. The carcass reinforcement 22 also has a crown reinforcement 24 as hoop reinforcement.

The crown reinforcement 24 is formed radially, from the inside to the outside:
from a first bilayer 25 comprising two plies 251, 252 not having free ends on the edges of the bilayer 25;
from a rubber layer 26 covering the end of the bilayer 25 and therefore the end of the ply 252;
from a second bilayer 27 comprising two plies 271, 272 identical to the bilayer 25 and produced substantially in the same manner, but with a smaller width;
from a second rubber layer 28 covering the end of the bilayer 27 and therefore the end of the ply 272; and
from a third bilayer 29 comprising two plies 291, 292 identical to the bilayers 25 and 27 and produced substantially in the same manner, but with a smaller width from that of the bilayer 27.

The crown reinforcement 24 also includes a protective ply 210 consisting of metal reinforcing elements, said ply being the radially outermost ply of the crown reinforcement 24.

The tire 21 therefore differs from the tire 1 of FIG. 1 by the presence of a rubber layer 28 and a third bilayer 29.

The width L₂₉ of the bilayer 29 is 260 mm.

The rubber layer 28, similar to the layer 26, covers the end of the bilayer 27 over a width l₂ of 35 mm and therefore over a length of greater than 1/10 of the width of said bilayer 27.

Since the bilayers 25, 27 and 29 are substantially formed in the same manner from the same strips and since the rubber layers 26 and 28 are substantially identical, all of the criteria associated with the radial distances between the reinforcing elements and the surface densities are also met by the reinforcing elements of the plies 271, 272, 291 and 292 of the bilayers 27 and 29 owing to the presence of the rubber layer 28.

Trials were carried out with aircraft tires of 46×17.0 R20 size, produced according to the invention as shown in FIG. 2, and other trials with control tires. The control tires did not have the rubber layers 26 and 28.

The trials consisted in running the tires on tracks simulating harsh operating conditions in terms of loads and speeds.

These trials demonstrated that, after running for around 250 km, the reinforcing elements of the crown reinforcement plies of the control tires were degraded and the calendering layers of said crown reinforcement plies had cracked regions at their ends.

Observation of the control tires demonstrated that none of the reinforcing elements of the crown reinforcement plies showed any sign of breakage and the calendering layers were not cracked at the ends of said crown reinforcement plies.

1.-13. (canceled)

14. A tire comprising a crown reinforcement formed from at least two bilayers of parallel reinforcing elements in a ply, which bilayers are distributed with a constant pitch and crossed from one ply to another, and which do not have a free end at the edges thereof, wherein, within a radial plane, a surface density of reinforcing elements in a region bounded by the geometric centers of four pairwise adjacent reinforcing elements, belonging in pairs to a bilayer, and forming a quadrilateral, is greater at the center of the tire than at the ends of the bilayers.

15. The tire according to claim 14, wherein, within a radial plane, at the ends of the bilayers, the surface density of reinforcing elements in a region bounded by the geometric centers of four pairwise adjacent reinforcing elements, belonging in pairs to a bilayer, and forming a quadrilateral, is less than 45%.

16. The tire according to claim 14, wherein, within a radial plane, at the center of the tire, the surface density of reinforcing elements in a region bounded by the geometric centers of four pairwise adjacent reinforcing elements, belonging in pairs to a bilayer, and forming a quadrilateral, is more than 55%.

17. A tire comprising a crown reinforcement formed from at least two bilayers of parallel reinforcing elements in a ply, which bilayers are distributed with a constant pitch and crossed from one ply to another, and which do not have a free end at the edges thereof, wherein, within a radial plane, at the end of the bilayers, the ratio of the radial distance between two reinforcing elements of two adjacent plies, each ply belonging to a bilayer, to the radial distance between two reinforcing elements of the two plies of a bilayer is greater than 1.5.

18. Tire according to claim 14 or 17, wherein at least one layer of polymer compound is placed radially between the ends of two bilayers.

19. The tire according to claim 18, wherein, within a radial plane, the axially inner end of said at least one layer of polymer compound is at an axial distance from the equatorial plane of less than ⅘ of the axial half-width of the widest bilayer to which it is adjacent.

20. The tire according to claim 18, wherein, within a radial plane, the axially outer end of said at least one layer of polymer compound is axially to the outside of the axially outer end of the widest bilayer to which it is adjacent.

21. The tire according to claim 14 or 17, wherein the reinforcing elements of the crown reinforcement plies are inclined at an angle of between −20° and +20° to the circumferential direction.

22. The tire according to claim 14 or 17, wherein the reinforcing elements of the crown reinforcement plies are made of textile materials.

23. The tire according to claim 14 or 17, when the crown reinforcement of said tire comprises at least one ply of circumferential reinforcing elements, wherein the circumferential reinforcing elements are made of textile materials.

24. The tire according to claim 14 or 17, the tire comprising a carcass reinforcement comprising at least one ply of mutually parallel reinforcing elements oriented substantially radially, wherein the reinforcing elements of said at least one carcass reinforcement ply are made of textile materials.
